(19) United States
(12) Patent Application Publication
(10) Pub. No.: US 2026/0352688 A1
(43) Pub. Date: Nov. 5, 2026

(54) TAMPER-PROTECTED SECURITY TOOL DISABLEMENT IN AUTONOMOUS PENTESTING

(71) Applicant: Horizon 3 AI, Inc., Dover, DE (US)

(72) Inventors: James Walter Horseman, Wesley Chapel, FL (US); John Samuel Bass, New Braunfels, TX (US); Zachary Daniel Hanley, Apex, NC (US)

(21) Appl. No.: 19/183,302

(22) Filed: Apr. 18, 2025

(51) Int. Cl. H04L 9/40; G06F 9/451

(52) U.S. Cl. CPC H04L 63/1433; G06F 9/451

(57) ABSTRACT

An autonomous pentesting agent may disable security settings by analyzing a graphical user interface (GUI). The agent may remotely access, during an autonomous pentest, the GUI of a network asset using a tool that enables communication of keyboard, video, and mouse (KVM) signals. The agent may perform deterministic operations causing display of security settings of an endpoint detection and response (EDR) system at the GUI. The agent may capture, using the tool, a screenshot of the GUI displaying the security settings and obtain, based on the screenshot of the GUI, vectors between a cursor on the GUI and a GUI element corresponding to a security setting. The agent may disable the security setting by using the tool to navigate the cursor to the GUI element via the vectors and interacting with the GUI element. After disabling the security setting, the agent may perform autonomous pentesting operations.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support tamper-protected security tool disablement in autonomous pentesting.

In some aspects, the techniques described herein relate to a method for disabling a tamper-protected security tool via autonomous pentesting, including: performing, during an autonomous pentest of a network, one or more first autonomous pentesting operations including remotely accessing a graphical user interface (GUI) of a network asset of the network using a tool that enables communication of keyboard, video, and mouse (KVM) signals across the network; performing, based at least in part on accessing the GUI, one or more deterministic operations causing display of one or more security settings of an endpoint detection and response (EDR) system at the GUI of the network asset; capturing, using the tool and based at least in part on performing the one or more deterministic operations, a screenshot of the GUI displaying the one or more security settings of the EDR system; obtaining, based at least in part on the screenshot of the GUI, one or more vectors between a cursor on the GUI and a GUI element corresponding to a security setting of the one or more security settings; disabling the security setting based at least in part on using the tool to navigate the cursor to the GUI element via the one or more vectors and interacting with the GUI element; and performing, during the autonomous pentest, one or more second autonomous pentesting operations after disabling the security setting.

In some aspects, the techniques described herein relate to an apparatus for disabling a tamper-protected security tool via autonomous pentesting, including: one or more memories storing processor-executable code; and one or more processors coupled with the one or more memories and individually or collectively operable to execute the code to cause the apparatus to: perform, during an autonomous pentest of a network, one or more first autonomous pentesting operations including remotely accessing a GUI of a network asset of the network using a tool that enables communication of KVM signals across the network; perform, based at least in part on accessing the GUI, one or more deterministic operations causing display of one or more security settings of an EDR system at the GUI of the network asset; capture, using the tool and based at least in part on performing the one or more deterministic operations, a screenshot of the GUI displaying the one or more security settings of the EDR system; obtain, based at least in part on the screenshot of the GUI, one or more vectors between a cursor on the GUI and a GUI element corresponding to a security setting of the one or more security settings; disable the security setting based at least in part on using the tool to navigate the cursor to the GUI element via the one or more vectors and interacting with the GUI element; and perform, during the autonomous pentest, one or more second autonomous pentesting operations after disabling the security setting.

In some aspects, the techniques described herein relate to a non-transitory computer-readable medium storing code for disabling a tamper-protected security tool via autonomous pentesting, the code including instructions executable by one or more processors to: perform, during an autonomous pentest of a network, one or more first autonomous pentesting operations including remotely accessing a GUI of a network asset of the network using a tool that enables communication of KVM signals across the network; perform, based at least in part on accessing the GUI, one or more deterministic operations causing display of one or more security settings of an EDR system at the GUI of the network asset; capture, using the tool and based at least in part on performing the one or more deterministic operations, a screenshot of the GUI displaying the one or more security settings of the EDR system; obtain, based at least in part on the screenshot of the GUI, one or more vectors between a cursor on the GUI and a GUI element corresponding to a security setting of the one or more security settings; disable the security setting based at least in part on using the tool to navigate the cursor to the GUI element via the one or more vectors and interacting with the GUI element; and perform, during the autonomous pentest, one or more second autonomous pentesting operations after disabling the security setting.

### BRIEF DESCRIPTION OF THE DRAWINGS

FIG. 1 shows an example of a computing environment that supports tamper-protected security tool disablement in autonomous pentesting in accordance with aspects of the present disclosure.

FIG. 2 shows an example of an autonomous pentest map that supports tamper-protected security tool disablement in autonomous pentesting in accordance with aspects of the present disclosure.

FIG. 3 shows an example of a computing environment that supports tamper-protected security tool disablement in autonomous pentesting in accordance with aspects of the present disclosure.

FIG. 4 shows an example of a computing environment that supports tamper-protected security tool disablement in autonomous pentesting in accordance with aspects of the present disclosure.

FIG. 5 shows an example of a process flow that supports tamper-protected security tool disablement in autonomous pentesting in accordance with aspects of the present disclosure.

FIG. 6 shows a diagram of a system including a device that supports tamper-protected security tool disablement in autonomous pentesting in accordance with aspects of the present disclosure.

FIG. 7 shows a flowchart illustrating methods that support tamper-protected security tool disablement in autonomous pentesting in accordance with aspects of the present disclosure.

### DETAILED DESCRIPTION

Some computing environments may include security software (e.g., Windows Defender) that provides protection against viruses, malware, and other security threats to computing devices. In some cases, security software may include tamper protection features or other security settings which may prevent unauthorized deactivation of the security software. Tamper protection features may be configured such that a genuine user interface interaction is used to disable the tamper protection, confirming that a human (e.g., human interaction via the GUI) initiated the request. For example, a human may disable a tamper protection feature on a computing device by logging into an operating system (OS) of the computing device, navigating through one or more menus, and manually clicking a button associated with the tamper protection feature on a graphical user interface (GUI). While an automated script may be capable of logging into the OS of the computing device and navigating through menus using deterministic operations (e.g., commands), the automated script may be unable to engage (e.g., activate, deactivate, toggle, select) the button on the GUI to disable the tamper protection feature. In some examples, tools may attempt to engage the button by reading a bitmap of pixel data of the GUI, but such attempts may be unreliable. For example, it may be difficult to write an automated process that has a high success rate based on the input being a bitmap, as the bitmap is a matrix of pixel values. In order to correctly analyze the bitmap and identify the button, the process may first analyze the bitmap data to identify the button across menus of the security software including multiple settings having similar GUI buttons and across varying menus of different hosts. Accordingly, it may be difficult for a non-human pentester (e.g., a pentesting agent) to disable the tamper protection feature and, in turn, disable the security software. In such cases, the non-human pentester may be limited in pentesting operations as the security software may detect and disable operations performed during a pentest.

An autonomous pentesting agent described herein may disable a tamper protection feature of security software—such as an endpoint detection and response (EDR) system—via a tool that enables communication of keyboard, video, and mouse (KVM) signals. For example, the autonomous pentesting agent may access a menu of the EDR system (e.g., via deterministic operations) and capture a screenshot of a GUI using the tool. The autonomous pentesting agent may identify one or more vectors between a cursor and a GUI element corresponding to the tamper protection feature and send a KVM signal instructing the cursor to navigate (e.g., move) from an initial cursor position to a subsequent cursor position based on the one or more vectors. In some examples, the autonomous pentesting agent may perform multiple iterations of capturing a screenshot, identifying one or more vectors, and navigating the cursor to traverse from the original position of the cursor on the GUI (prior to an initial screenshot) to the GUI element. After the autonomous pentesting agent navigates the cursor and interacts with the GUI element to disable the tamper protection setting, the autonomous pentesting agent may then disable the EDR system and perform autonomous pentesting operations that may not have been available to the autonomous pentesting agent when the EDR system was enabled. Accordingly, such techniques allow the autonomous pentesting agent to perform an autonomous pentest with increased capabilities (e.g., more operations or higher severity operations) compared to a pentest in which the EDR system is enabled.

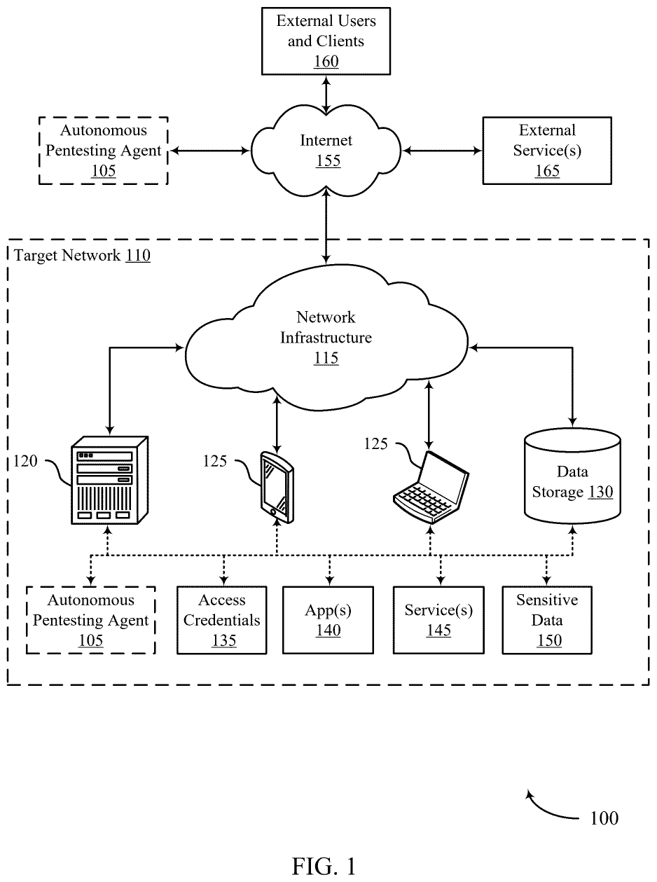

FIG. 1 illustrates an example of a computing environment 100 that supports tamper-protected security tool disablement in autonomous pentesting in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, WiFi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and services 145 that are governed or configured by one or more domain controllers and operate in accordance with policies that are put in place and managed by the one or more domain controllers. The domain may be divided into multiple subdomains or groups containing respective subsets of components, users (e.g., access credentials 135), and services 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access the one or more network assets (credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

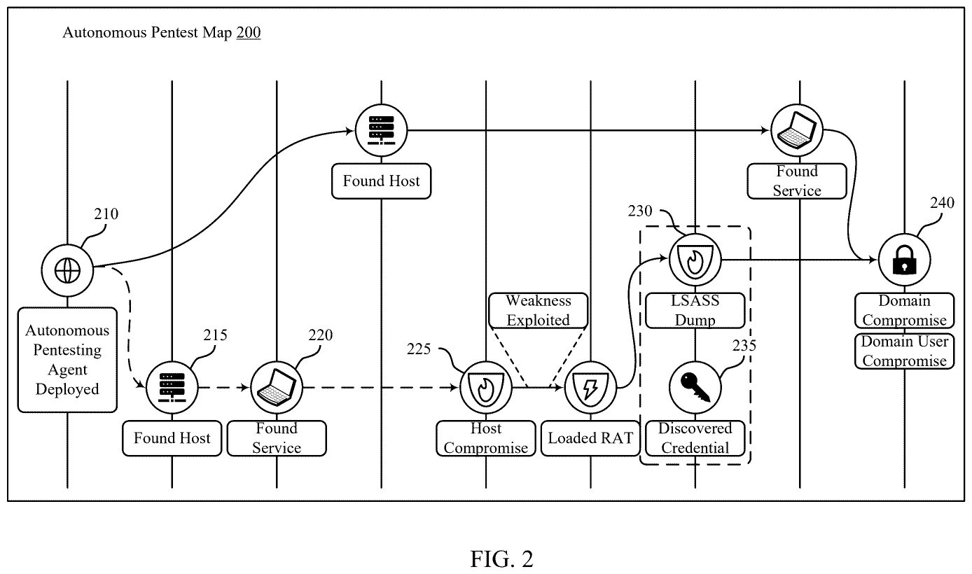

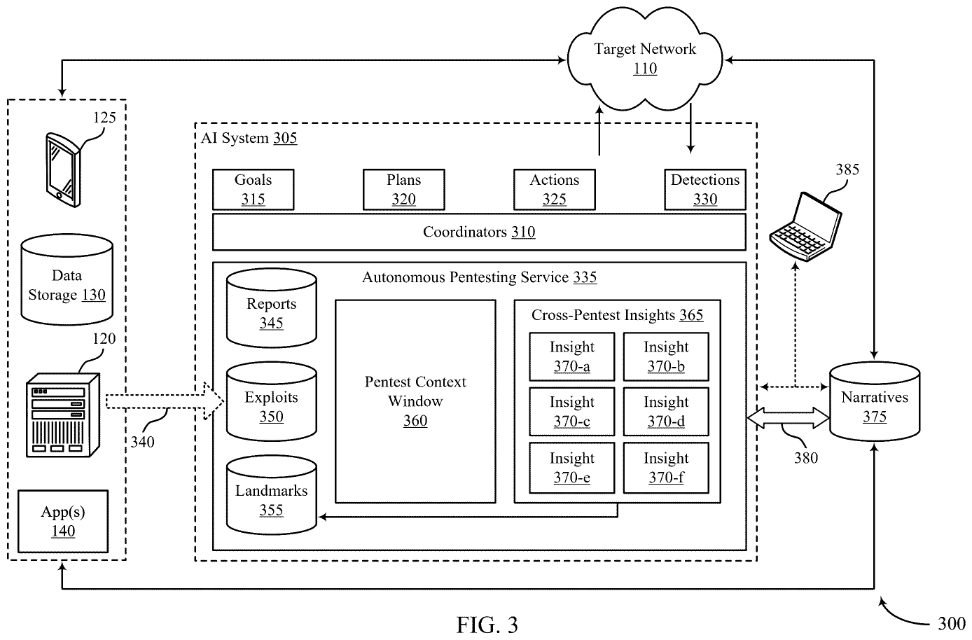

The autonomous pentesting agent 105 may perform a pentest of the target network 110. As used herein, a penetration test or a “pentest” may refer to the performance of one or more security operations that simulate a cybersecurity attack in order to identify vulnerabilities in the target network 110. The autonomous pentesting agent 105 may perform the pentest of the target network 110 using one or more artificial intelligence (AI) models. For example, the autonomous pentesting agent 105 may be “autonomous” in that the autonomous pentesting agent 105 may perform the pentest without hard-coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access initially and, from that asset, another asset to attempt to access, and so on. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed at the Internet 155. For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, that enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein, the autonomous pentesting agent 105 may perform one or more operations to disable a tamper protection setting, an EDR system, or both. For example, the autonomous pentesting agent 105 may use a tool to communicate KVM signals, including screenshots and mouse navigation information, which the autonomous pentesting agent 105 may use to identify and navigate a cursor to a GUI element corresponding to the tamper protection setting. Accordingly, the autonomous pentesting agent 105 may support automated tamper protection tool disablement that may otherwise involve physical user interaction (e.g., human input), which may reduce latency associated with obtaining user inputs and bypassing EDR enabled systems. For example, the autonomous pentesting agent 105 may disable the tamper protection setting at scale during an autonomous pentest. That is, the autonomous pentesting agent 105 may disable tamper protection across thousands of hosts in a short period of time (e.g., compared to disabling tamper protection via manual user input). Additionally, or alternatively, the autonomous pentesting agent 105 may implement a large language model (LLM) to interpret screenshots, allowing the autonomous pentesting agent 105 to engage with complex dialogs, toggles, and confirmation prompts. By disabling the tamper protection setting and the EDR system, the autonomous pentesting agent 105 may support extended capabilities for performing autonomous pentesting operations, including deploying additional software (e.g., additional agents, implants, etc.), which may allow the autonomous pentesting agent 105 to identify weaknesses or vulnerabilities in the network 110 otherwise shielded or protected by the EDR system. Identifying such weaknesses or vulnerabilities may allow the autonomous pentesting agent 105 to provide a more comprehensive evaluation of network security, including identifying network assets that may be vulnerable if an attack on the EDR system were to occur.

FIG. 2 shows an example of an autonomous pentest map 200 that supports tamper-protected security tool disablement in autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support one or more operations in accordance with disabling a security setting. For example, the autonomous pentesting service may disable a tamper protection setting and, in turn, disable an EDR system of a computing device in the autonomous pentest map 200. Disabling the EDR system may allow the autonomous pentesting service to perform one or more operations in the autonomous pentest map 200, such as deployment of an attacker tool 230 (e.g., loading a RAT and performing an LSASS dump). In such examples, by disabling the EDR system using techniques described herein, the autonomous pentesting service may identify weaknesses and vulnerabilities via the attacker tool 230 based on the EDR system being disabled. Accordingly, the autonomous pentesting service may identify weaknesses and vulnerabilities in a network that may not be identified when the EDR system is enabled while performing the pentest autonomously (e.g., without user input or human intervention).

FIG. 3 shows an example of a computing environment 300 that supports tamper-protected security tool disablement in autonomous pentesting in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate one or more plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service 335 may utilize the AI system 305 to identify, from a screenshot of a GUI, one or more vectors between a cursor and a GUI element corresponding to a tamper protection setting. For example, the AI system 305 may include an LLM, which the AI system 305 may use to interpret the screenshot of the GUI to identify a location of the cursor, a location of the GUI element, and one or more vectors between the cursor and the GUI element. Additionally, the AI system 305 may use the LLM to generate vectors that mimic human movement of the cursor. For example, the LLM may generate one or more vectors between the cursor and the GUI element that include some level of randomness, smoothing, or timing to emulate human-like movement.

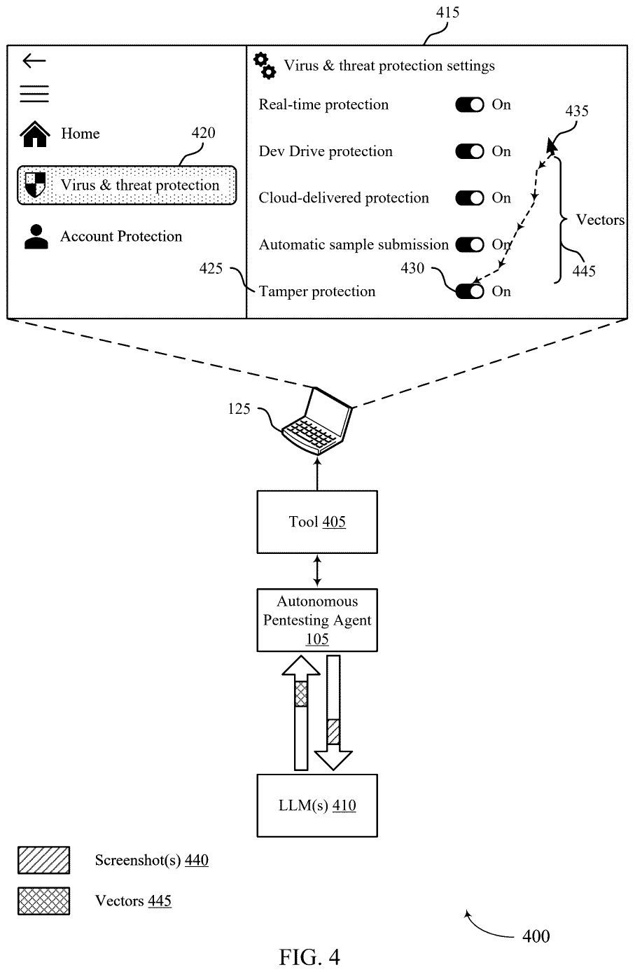

FIG. 4 shows an example of a computing environment 400 that supports tamper-protected security tool disablement in autonomous pentesting in accordance with aspects of the present disclosure. The computing environment 400 may implement or be implemented by the computing environment 100, the autonomous pentest map 200, the computing environment 300, or any combination thereof. For example, the computing environment 400 may illustrate an autonomous pentesting agent 105 disabling a tamper protection setting at a computing device 125.

The autonomous pentesting agent 105 may use the tool 405 to remotely perform one or more operations described herein at the computing device 125. The autonomous pentesting agent 105 may use the tool 405 based on accessing the computing device 125 in an unauthorized manner during pentesting (e.g., using credentials, such as valid Windows credentials, found during a pentest), being granted remote access by a user for pentesting (e.g., as part of a deployment configuration), or the like. The tool 405 may be an example of a Remote Desktop Protocol (RDP) tool (e.g., as part of an RDP session), a Virtual Network Computing (VNC) tool (e.g., as part of a VNC protocol), or the like. For example, the tool 405 may refer to any tool allowing communication (e.g., transmission, reception, exchange) of KVM signals across a network to remotely access GUIs of computing devices. In some examples, the computing device 125 may include the tool 405 prior to the autonomous pentesting agent 105 compromising the computing device 125. The autonomous pentesting agent 105 may use the tool 405 to establish a connection with and remotely perform operations at the computing device 125. The computing device 125 may, in some examples, be referred to as a target machine and/or be an example of a Windows machine (e.g., a device having a Microsoft Windows-based OS installed thereon).

After accessing the computing device 125 and establishing the connection via the tool 405, the autonomous pentesting agent 105 may perform one or more deterministic operations. For example, the autonomous pentesting agent 105 may execute deterministic operations that launch a security settings panel (e.g., a Windows Defender panel) on a GUI 415 of the computing device 125. As used herein, a deterministic operation may refer to an operation involving consistent inputs and consistent outputs. That is, deterministic operations may include keyboard shortcuts, scripted commands, or the like, that are interpreted by the computing device 125 consistently. As an example, the autonomous pentesting agent 105 may open “Run” or “Command Prompt” and issue commands to open, navigate, or access features of a control panel using the tool 405. The security settings panel, an example of which is included in the GUI 415 shown with reference to FIG. 4, may be associated with security software operating on the computing device 125 and may include one or more menus, each of which including a respective group of settings associated with the security software. For example, the security settings panel may include a virus & threat protection menu 420, which may include settings related to real-time protection, dev drive protection, cloud-delivered protection, automatic sample submission, and tamper protection 425.

The autonomous pentesting agent 105, via the tool 405 (e.g., by communicating signals with the tool 405), may capture screenshot(s) 440 of the GUI 415 (e.g., of the RDP session or VNC protocol) after performing the one or more deterministic operations that display the security settings panel. For example, the autonomous pentesting agent 105 may perform a command (e.g., a keyboard command, a script command, etc.) to capture a screenshot of the GUI 415 of the computing device 125 using the tool 405. Based on the screenshot(s) 440, the autonomous pentesting agent 105 may identify a GUI element 430 corresponding to the tamper protection 425 setting, a cursor 435, and vectors 445 between the cursor 435 and the GUI element 430. The GUI element 430 may be an example of a button or another interactive element that may be engaged to trigger an action or submit a form. In the example of the GUI element 430 corresponding to the tamper protection 425 feature, interacting with the GUI element 430 may enable or disable the tamper protection 425 feature. As used herein, “interacting with” the GUI element may refer to engaging, selecting, clicking, or toggling the GUI element 430.

In some examples, the autonomous pentesting agent 105 may use LLM(s) 410 to identify the GUI element 430, the cursor 435, and/or the vectors 445. For example, the autonomous pentesting agent 105 may send the screenshot(s) 440 of the GUI 415 to the LLM(s) 410, which may interpret the on-screen layout and determine how to move the cursor 435. For instance, the LLM(s) 410 may detect a relative position of the GUI element 430 (e.g., a “Tamper Protection” switch or toggle) in the displayed interface. The LLM(s) 410 may respond to the autonomous pentesting agent 105 with one or more commands to guide the cursor (e.g., on a pixel-by-pixel basis according to the vectors 445) toward the GUI element 430. That is, the LLM(s) 410 may send the vectors 445 to the autonomous pentesting agent 105, where the vectors 445 may be in terms of pixels of the GUI 415 (e.g., a unit of the vectors 445 may involve pixels). In some examples, the vectors 445 may include randomness to mimic human-like movement. That is, the vectors 445 may, rather than being a single vector from the cursor to the GUI element 430, be a spline or series of multiple vectors that follow a path from the cursor 435 to the GUI element 430. The LLM(s) 410 may determine vectors that mimic human movement to prevent detection from the EDR system, based on an input from the autonomous pentesting agent 105, or both.

The autonomous pentesting agent 105 may obtain the vectors 445 from the LLM(s) 410 and navigate the cursor 435 in accordance with the vectors 445. In some examples, the autonomous pentesting agent 105 may perform multiple iterations of capturing screenshots, identifying vectors via the LLM(s) 410, and navigating the cursor 435 before interacting with the GUI element 430. That is, the autonomous pentesting agent 105 may capture a first screenshot (e.g., after performing the deterministic operations), identify one or more first vectors, and execute a first cursor movement along the one or more first vectors. Then, the autonomous pentesting agent 105 may capture a second screenshot, identify one or more second vectors based on the updated position of the cursor 435, and execute a second cursor movement along the one or more second vectors. Put another way, after each cursor movement, the autonomous pentesting agent 105 may capture a new screenshot and feed it to the LLM(s) 410 for updated instructions until the cursor 435 is at a same location on the GUI 415 as the GUI element 430.

In some examples, after performing the one or more deterministic operations to launch the security settings panel, the GUI element associated with tamper protection 425 may not be on the GUI 415. In such examples, the LLM(s) 410 may identify from a screenshot that the tamper protection 425 setting is absent from the GUI 415, and the autonomous pentesting agent 105 may use the tool 405 to scroll and capture another screenshot. In other words, the LLM(s) 410 may indicate one or more instructions to the autonomous pentesting agent 105, including to scroll the virus & threat protection menu 420 to display the tamper protection 425 setting, prior to indicating the vectors 445.

With tamper protection 425 disabled, the autonomous pentesting agent 105 may disable the EDR system in an automated manner. For example, the autonomous pentesting agent 105 may disable tamper protection 425 by interacting with the GUI element 430 and, thereafter, issue one or more deterministic commands to disable the EDR system. When disabled, the EDR system may not actively monitor the computing device 125 and/or detect subsequent autonomous pentesting operations by the autonomous pentesting agent 105. Accordingly, the autonomous pentesting agent 105 may perform operations such as deploying additional software (e.g., a customized agent or implant) without detection or interference from the EDR system (e.g., from antivirus routines of the EDR system). In other words, the autonomous pentesting agent 105 may perform pentesting operations that may not be available if the EDR system were enabled.

In some examples, techniques described herein may be applied to one or more other EDR systems involving interaction with a GUI to disable one or more security settings (e.g., including GUI-based restrictions). For example, the autonomous pentesting agent 105 may capture and analyze screenshots to bypass security checks, including Completely Automated Public Turing test to tell Computers and Humans Apart (CAPTCHA) tests (e.g., “are you human” tests). The autonomous pentesting agent 105 may use the LLM(s) 410 to identify a requested action by the CAPTCHA tests and use the tool 405 to perform the requested action at the GUI 415.

Additionally, or alternatively, techniques described herein may be utilized to compromise credentials during autonomous pentesting. For example, the autonomous pentesting agent 105 may use the tool 405 and the LLM(s) 410 to launch a password manager at the computing device. The password manager may include one or more stored passwords associated with one or more user accounts accessed via the computing device 125 and, in some examples, may support Time-based One-Time Passwords (TOTPs). For example, the password manager may generate TOTPs based on the current time as a source of uniqueness. The autonomous pentesting agent 105 may use the tool 405, the LLM(s) 410, or both to launch a browser on the computing device 125, navigate to a page, recognize a login prompt, and attempt to bypass the login prompt using the password manager. For example, the autonomous pentesting agent 105 may identify a TOTP string (e.g., a combination of numbers, letters, and special characters) using the LLM(s) 410 and input the TOTP string to a TOTP challenge box on the GUI 415. Accordingly, the autonomous pentesting agent 105 may identify weaknesses and vulnerabilities associated with use of the password manager and demonstrate that the computing device 125 is vulnerable to an attack.

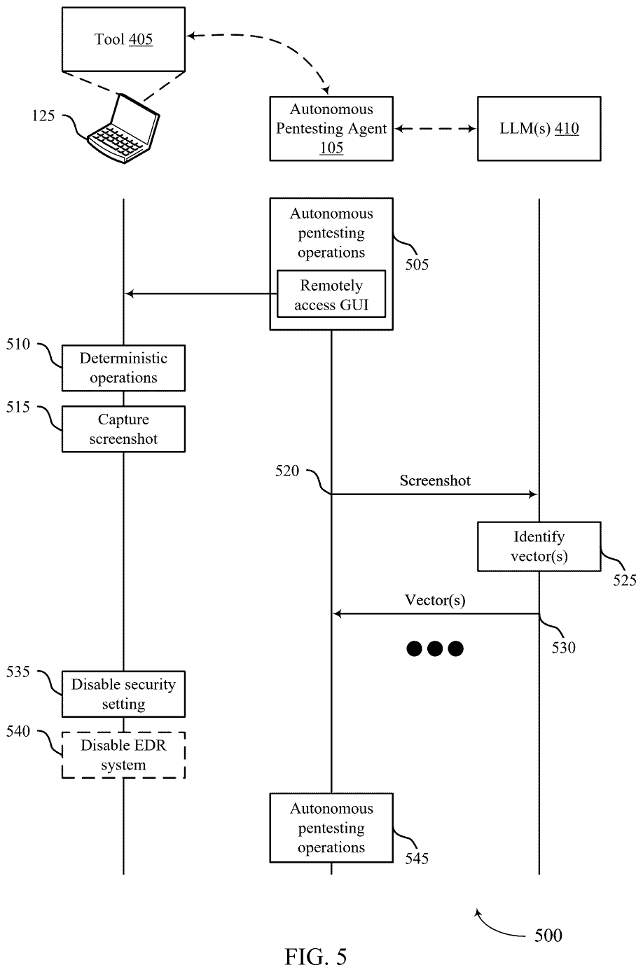

FIG. 5 shows an example of a process flow 500 that supports tamper-protected security tool disablement in autonomous pentesting in accordance with aspects of the present disclosure. The process flow 500 may implement or be implemented by the computing environment 100, the autonomous pentest map 200, the computing environment 300, the computing environment 400, or any combination thereof. For example, the process flow 500 may illustrate operations between components of the computing environment 400.

Alternative examples of the following may be implemented, where some operations are performed in a different order than described or are not performed at all. In some examples, operations may include additional features not mentioned below, or further operations may be added. Although the computing device 125, the tool 405, the autonomous pentesting agent 105, and the LLM(s) 410 are shown performing the operations of the process flow 500, some aspects of some operations may also be performed by one or more other devices or systems.

At 505, the autonomous pentesting agent 105 may execute one or more autonomous pentesting operations, which may include remotely accessing a GUI of a computing device 125 via a tool 405. For example, the autonomous pentesting agent 105 may perform, during an autonomous pentest of a network, one or more first autonomous pentesting operations including remotely accessing a GUI of the computing device 125 (e.g., a network asset) of the network using a tool 405 that enables communication of KVM signals across the network. The GUI may be an example of the GUI 415 as described with reference to FIG. 4. Additionally, or alternatively, the tool may be an example of an RDP session tool or a VNC protocol tool.

At 510, the tool 405 may perform one or more deterministic operations at the computing device 125. For example, autonomous pentesting agent 105 (using the tool 405) may perform, based on accessing the GUI, one or more deterministic operations causing display of one or more security settings of an EDR system at the GUI of the computing device 125. The deterministic operations may be examples of keyboard shortcuts (e.g., Windows key +X then S to open Windows settings), scripts, or both.

At 515, the tool 405 may capture a screenshot of the GUI of the computing device 125. For example, the autonomous pentesting agent 105 may use the tool 405 to capture, based on performing the one or more deterministic operations, a screenshot of the GUI displaying the one or more security settings of the EDR system. In some examples, a target security setting (e.g., tamper protection) may not be visible on an initial screenshot. In such examples, the autonomous pentesting agent 105 may identify, using the LLM(s) 410, that the security setting is absent from the screenshot and use the tool 405 to adjust a window (e.g., to scroll) on the GUI corresponding to the security setting.

At 520, the autonomous pentesting agent 105 may send the screenshot to the LLM(s) 410. For example, the autonomous pentesting agent 105 may transmit, to a service associated with the LLM(s) 410, a request for one or more vectors between the cursor on the GUI and the GUI element corresponding to the security setting, the request including the screenshot of the GUI. Additionally, or alternatively, the autonomous pentesting agent 105 may input the screenshot of the GUI to the LLM(s) 410 based on capturing the screenshot of the GUI. In other words, the LLM(s) 410 may be external to the autonomous pentesting agent 105 or a component of the autonomous pentesting agent 105.

At 525, the LLM(s) 410 may identify vector(s). For example, the autonomous pentesting agent 105 may identify, using the LLM(s) 410, one or more vectors based on a first location of the cursor on the GUI and a second location of the GUI element on the GUI, where the one or more vectors correspond to a path between the first location and the second location. In some examples, the one or more vectors may be indicative of a natural movement of the cursor. That is, the LLM(s) 410 may generate the one or more vectors to mimic human movement of a cursor.

At 530, the LLM(s) 410 may send the vector(s) to the autonomous pentesting agent 105. For example, the autonomous pentesting agent 105 may obtain, based on the screenshot of the GUI, one or more vectors between a cursor on the GUI and a GUI element corresponding to a security setting of the one or more security settings. That is, the LLM(s) 410 may transmit an indication of the one or more vectors to the autonomous pentesting agent 105 in response to a request or output the one or more vectors based on an input of the screenshot.

In some examples, the autonomous pentesting agent 105 may perform multiple iterations of capturing screenshots, identifying vectors, and navigating the cursor. For example, the autonomous pentesting agent 105 may obtain, after capturing a first screenshot, a first vector of the one or more vectors between the cursor and the GUI element. Then, the autonomous pentesting agent 105 may capture, after using the tool to navigate the cursor via the first vector, a second screenshot of the GUI and obtain, based on the second screenshot of the GUI, a second vector of the one or more vectors between the cursor and the GUI element.

At 535, the tool 405 may disable a security setting at the computing device 125. For example, the autonomous pentesting agent 105 may use the tool 405 to disable the security setting based on navigating the cursor to the GUI element via the one or more vectors and interacting with the GUI element. The security setting may be an example of a tamper protection setting, such as the tamper protection 425 as described with reference to FIG. 4. At 540, the tool 405 may disable an EDR system at the computing device 125. For example, the autonomous pentesting agent 105 may use the tool to disable, after disabling the security setting, the EDR system.

At 545, the autonomous pentesting agent 105 may execute one or more autonomous pentesting operations. For example, the autonomous pentesting agent 105 may perform, during the autonomous pentest, one or more second autonomous pentesting operations after disabling the security setting and/or the EDR system. In some examples, the autonomous pentesting agent 105 may select the one or more second autonomous pentesting operations from a first set of autonomous pentesting operations available based on the EDR system being disabled. The first set of autonomous pentesting operations may be different from a second set of autonomous pentesting operations available when the EDR system is enabled. That is, the autonomous pentesting agent 105 may perform different operations when the EDR system is disabled, revealing weaknesses and vulnerabilities that may have otherwise been undetected during the autonomous pentest.

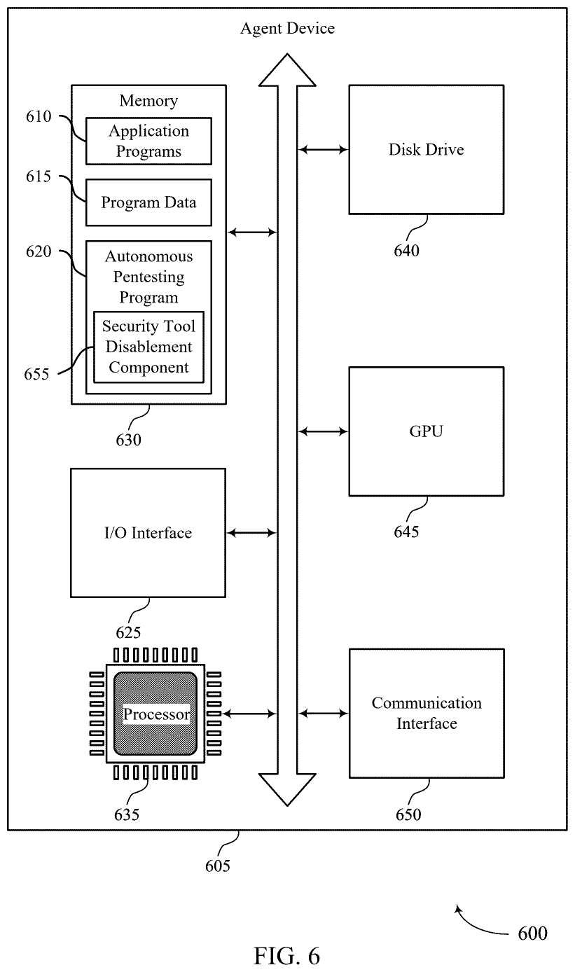

FIG. 6 shows a diagram of a system 600 including an agent device 605 that supports tamper-protected security tool disablement in autonomous pentesting in accordance with aspects of the present disclosure. The agent device 605 may be an example of a device or server on which an autonomous pentesting agent 105 is deployed as described herein. The agent device 605 may include components for tamper-protected security tool disablement in autonomous pentesting, such as a memory 630 including application programs 610, program data 615, an autonomous pentesting program 620, and a security tool disablement component 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting tamper-protected security tool disablement in autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting tamper-protected security tool disablement in autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving disabling a tamper-protected security tool via autonomous pentesting.

The security tool disablement component 655 may support disabling a tamper-protected security tool via autonomous pentesting in accordance with examples as disclosed herein. For example, the security tool disablement component 655 may be configured as or otherwise support a means for performing, during an autonomous pentest of a network, one or more first autonomous pentesting operations including remotely accessing a GUI of a network asset of the network using a tool that enables communication of KVM signals across the network. The security tool disablement component 655 may be configured as or otherwise support a means for performing, based on accessing the GUI, one or more deterministic operations causing display of one or more security settings of an EDR system at the GUI of the network asset. The security tool disablement component 655 may be configured as or otherwise support a means for capturing, using the tool and based on performing the one or more deterministic operations, a screenshot of the GUI displaying the one or more security settings of the EDR system. The security tool disablement component 655 may be configured as or otherwise support a means for obtaining, based on the screenshot of the GUI, one or more vectors between a cursor on the GUI and a GUI element corresponding to a security setting of the one or more security settings. The security tool disablement component 655 may be configured as or otherwise support a means for disabling the security setting based on using the tool to navigate the cursor to the GUI element via the one or more vectors and interacting with the GUI element. The security tool disablement component 655 may be configured as or otherwise support a means for performing, during the autonomous pentest, one or more second autonomous pentesting operations after disabling the security setting.

By including or configuring the security tool disablement component 655 in accordance with examples as described herein, the agent device 605 may support techniques for improved network security.

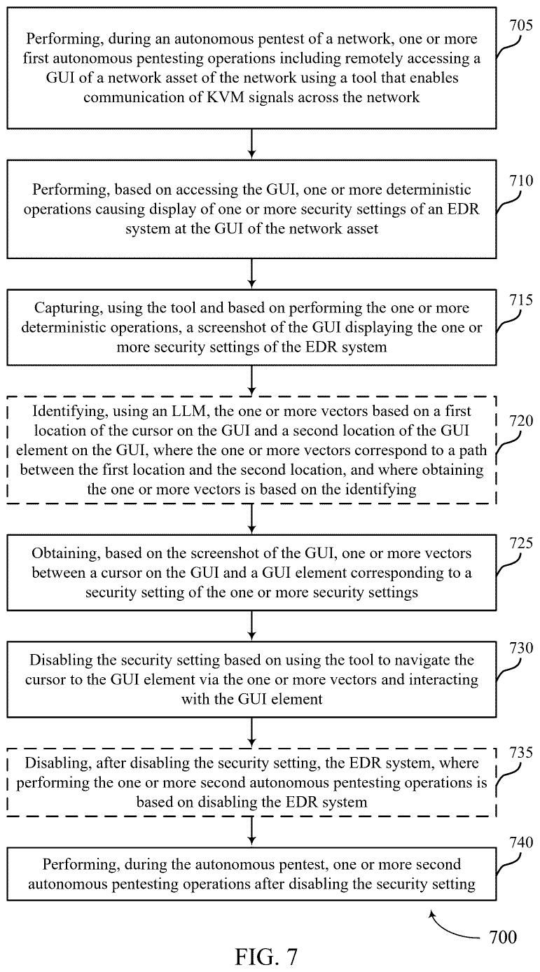

FIG. 7 shows a flowchart illustrating a method 700 that supports tamper-protected security tool disablement in autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include performing, during an autonomous pentest of a network, one or more first autonomous pentesting operations comprising remotely accessing a GUI of a network asset of the network using a tool that enables communication of KVM signals across the network.

At 710, the method 700 may include performing, based on accessing the GUI, one or more deterministic operations causing display of one or more security settings of an EDR system at the GUI of the network asset.

At 715, the method 700 may include capturing, using the tool and based on performing the one or more deterministic operations, a screenshot of the GUI displaying the one or more security settings of the EDR system.

At 720, the method 700 may include identifying, using an LLM, the one or more vectors based on a first location of the cursor on the GUI and a second location of the GUI element on the GUI, where the one or more vectors correspond to a path between the first location and the second location, and where obtaining the one or more vectors is based on the identifying.

At 725, the method 700 may include obtaining, based on the screenshot of the GUI, one or more vectors between a cursor on the GUI and a GUI element corresponding to a security setting of the one or more security settings.

At 730, the method 700 may include disabling the security setting based on using the tool to navigate the cursor to the GUI element via the one or more vectors and interacting with the GUI element.

At 735, the method 700 may include disabling, after disabling the security setting, the EDR system, where performing the one or more second autonomous pentesting operations is based on disabling the EDR system.

At 740, the method 700 may include performing, during the autonomous pentest, one or more second autonomous pentesting operations after disabling the security setting.

The following provides an overview of aspects of the present disclosure:

Aspect 1: A method for disabling a tamper-protected security tool via autonomous pentesting, comprising: performing, during an autonomous pentest of a network, one or more first autonomous pentesting operations comprising remotely accessing a GUI of a network asset of the network using a tool that enables communication of KVM signals across the network; performing, based at least in part on accessing the GUI, one or more deterministic operations causing display of one or more security settings of an EDR system at the GUI of the network asset; capturing, using the tool and based at least in part on performing the one or more deterministic operations, a screenshot of the GUI displaying the one or more security settings of the EDR system; obtaining, based at least in part on the screenshot of the GUI, one or more vectors between a cursor on the GUI and a GUI element corresponding to a security setting of the one or more security settings; disabling the security setting based at least in part on using the tool to navigate the cursor to the GUI element via the one or more vectors and interacting with the GUI element; and performing, during the autonomous pentest, one or more second autonomous pentesting operations after disabling the security setting.

Aspect 2: The method of aspect 1, further comprising: disabling, after disabling the security setting, the EDR system, wherein performing the one or more second autonomous pentesting operations is based at least in part on disabling the EDR system.

Aspect 3: The method of aspect 2, further comprising: selecting the one or more second autonomous pentesting operations from a first set of autonomous pentesting operations available based on the EDR system being disabled, wherein the first set of autonomous pentesting operations are at least partially different from a second set of autonomous pentesting operations available based on the EDR system being enabled.

Aspect 4: The method of any of aspects 1 through 3, further comprising: identifying, using an LLM, the one or more vectors based at least in part on a first location of the cursor on the GUI and a second location of the GUI element on the GUI, wherein the one or more vectors correspond to a path between the first location and the second location, and wherein obtaining the one or more vectors is based at least in part on the identifying.

Aspect 5: The method of any of aspects 1 through 4, further comprising: transmitting, to a service associated with an LLM, a request for the one or more vectors between the cursor on the GUI and the GUI element corresponding to the security setting, the request comprising the screenshot of the GUI, wherein the one or more vectors are obtained in response to the request from the service.

Aspect 6: The method of any of aspects 1 through 5, further comprising: inputting the screenshot of the GUI to an LLM based at least in part based on capturing the screenshot of the GUI, wherein obtaining the one or more vectors is based at least in part on inputting the screenshot to the LLM.

Aspect 7: The method of any of aspects 1 through 6, wherein obtaining the one or more vectors comprises: obtaining, after capturing the screenshot, a first vector of the one or more vectors between the cursor and the GUI element; capturing, after using the tool to navigate the cursor via the first vector, a second screenshot of the GUI; and obtaining, based at least in part on the second screenshot of the GUI, a second vector of the one or more vectors between the cursor and the GUI element.

Aspect 8: The method of any of aspects 1 through 7, further comprising: capturing a first screenshot of the GUI absent the one or more security settings of the EDR system; and using the tool to adjust a window on the GUI corresponding to the security setting based at least in part on the security setting being absent on the first screenshot, wherein capturing the screenshot of the GUI displaying the one or more security settings is based at least in part on using the tool to scroll.

Aspect 9: The method of any of aspects 1 through 8, wherein the one or more vectors are representative of a natural movement of the cursor.

Aspect 10: The method of any of aspects 1 through 9, wherein the security setting comprises a tamper protection setting.

Aspect 11: The method of any of aspects 1 through 10, wherein remotely accessing the GUI is via an RDP session or a VNC protocol.

Aspect 12: An apparatus for disabling a tamper-protected security tool via autonomous pentesting, comprising: one or more memories storing processor-executable code; and one or more processors coupled with the one or more memories and individually or collectively operable to execute the code to cause the apparatus to perform a method of any of aspects 1 through 11.

Aspect 13: A non-transitory computer-readable medium storing code for disabling a tamper-protected security tool via autonomous pentesting, the code comprising instructions executable by one or more processors to perform a method of any of aspects 1 through 11.

Aspect 14: An apparatus for disabling a tamper-protected security tool via autonomous pentesting, comprising at least one means for performing a method of any aspects 1 through 11.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for disabling a tamper-protected security tool via autonomous pentesting, comprising:
performing, during an autonomous pentest of a network, one or more first autonomous pentesting operations comprising remotely accessing a graphical user interface (GUI) of a network asset of the network using a tool that enables communication of keyboard, video, and mouse (KVM) signals across the network;
performing, based at least in part on accessing the GUI, one or more deterministic operations causing display of one or more security settings of an endpoint detection and response (EDR) system at the GUI of the network asset;
capturing, using the tool and based at least in part on performing the one or more deterministic operations, a screenshot of the GUI displaying the one or more security settings of the EDR system;
obtaining, based at least in part on the screenshot of the GUI, one or more vectors between a cursor on the GUI and a GUI element corresponding to a security setting of the one or more security settings;
disabling the security setting based at least in part on using the tool to navigate the cursor to the GUI element via the one or more vectors and interacting with the GUI element; and
performing, during the autonomous pentest, one or more second autonomous pentesting operations after disabling the security setting.

2. The method of claim 1, further comprising:
disabling, after disabling the security setting, the EDR system, wherein performing the one or more second autonomous pentesting operations is based at least in part on disabling the EDR system.

3. The method of claim 2, further comprising:
selecting the one or more second autonomous pentesting operations from a first set of autonomous pentesting operations available based on the EDR system being disabled, wherein the first set of autonomous pentesting operations are at least partially different from a second set of autonomous pentesting operations available based on the EDR system being enabled.

4. The method of claim 1, further comprising:
identifying, using a large language model (LLM), the one or more vectors based at least in part on a first location of the cursor on the GUI and a second location of the GUI element on the GUI, wherein the one or more vectors correspond to a path between the first location and the second location, and wherein obtaining the one or more vectors is based at least in part on the identifying.

5. The method of claim 1, further comprising:
transmitting, to a service associated with a large language model (LLM), a request for the one or more vectors between the cursor on the GUI and the GUI element corresponding to the security setting, the request comprising the screenshot of the GUI, wherein the one or more vectors are obtained in response to the request from the service.

6. The method of claim 1, further comprising:
inputting the screenshot of the GUI to a large language model (LLM) based at least in part based on capturing the screenshot of the GUI, wherein obtaining the one or more vectors is based at least in part on inputting the screenshot to the LLM.

7. The method of claim 1, wherein obtaining the one or more vectors comprises:
obtaining, after capturing the screenshot, a first vector of the one or more vectors between the cursor and the GUI element;
capturing, after using the tool to navigate the cursor via the first vector, a second screenshot of the GUI; and
obtaining, based at least in part on the second screenshot of the GUI, a second vector of the one or more vectors between the cursor and the GUI element.

8. The method of claim 1, further comprising:
capturing a first screenshot of the GUI absent the one or more security settings of the EDR system; and
using the tool to adjust a window on the GUI corresponding to the security setting based at least in part on the security setting being absent on the first screenshot, wherein capturing the screenshot of the GUI displaying the one or more security settings is based at least in part on using the tool to scroll.

9. The method of claim 1, wherein the one or more vectors are representative of a natural movement of the cursor.

10. The method of claim 1, wherein the security setting comprises a tamper protection setting.

11. The method of claim 1, wherein remotely accessing the GUI is via a remote desktop protocol (RDP) session or a virtual network computing (VNC) protocol.

12. An apparatus for disabling a tamper-protected security tool via autonomous pentesting, comprising:
one or more memories storing processor-executable code; and
one or more processors coupled with the one or more memories and individually or collectively operable to execute the code to cause the apparatus to:
perform, during an autonomous pentest of a network, one or more first autonomous pentesting operations comprising remotely accessing a graphical user interface (GUI) of a network asset of the network using a tool that enables communication of keyboard, video, and mouse (KVM) signals across the network;
perform, based at least in part on accessing the GUI, one or more deterministic operations causing display of one or more security settings of an endpoint detection and response (EDR) system at the GUI of the network asset;
capture, using the tool and based at least in part on performing the one or more deterministic operations, a screenshot of the GUI displaying the one or more security settings of the EDR system;
obtain, based at least in part on the screenshot of the GUI, one or more vectors between a cursor on the GUI and a GUI element corresponding to a security setting of the one or more security settings;
disable the security setting based at least in part on using the tool to navigate the cursor to the GUI element via the one or more vectors and interacting with the GUI element; and
perform, during the autonomous pentest, one or more second autonomous pentesting operations after disabling the security setting.

13. The apparatus of claim 12, wherein the one or more processors are individually or collectively further operable to execute the code the cause the apparatus to:
disable, after disabling the security setting, the EDR system, wherein performing the one or more second autonomous pentesting operations is based at least in part on disabling the EDR system.

14. The apparatus of claim 13, wherein the one or more processors are individually or collectively further operable to execute the code the cause the apparatus to:
select the one or more second autonomous pentesting operations from a first set of autonomous pentesting operations available based on the EDR system being disabled, wherein the first set of autonomous pentesting operations are at least partially different from a second set of autonomous pentesting operations available based on the EDR system being enabled.

15. The apparatus of claim 12, wherein the one or more processors are individually or collectively further operable to execute the code the cause the apparatus to:
identify, using a large language model (LLM), the one or more vectors based at least in part on a first location of the cursor on the GUI and a second location of the GUI element on the GUI, wherein the one or more vectors correspond to a path between the first location and the second location, and wherein obtaining the one or more vectors is based at least in part on the identifying.

16. The apparatus of claim 12, wherein the one or more processors are individually or collectively further operable to execute the code the cause the apparatus to:
transmit, to a service associated with a large language model (LLM), a request for the one or more vectors between the cursor on the GUI and the GUI element corresponding to the security setting, the request comprising the screenshot of the GUI, wherein the one or more vectors are obtained in response to the request from the service.

17. A non-transitory computer-readable medium storing code for disabling a tamper-protected security tool via autonomous pentesting, the code comprising instructions executable by one or more processors to:
perform, during an autonomous pentest of a network, one or more first autonomous pentesting operations comprising remotely accessing a graphical user interface (GUI) of a network asset of the network using a tool that enables communication of keyboard, video, and mouse (KVM) signals across the network;
perform, based at least in part on accessing the GUI, one or more deterministic operations causing display of one or more security settings of an endpoint detection and response (EDR) system at the GUI of the network asset;
capture, using the tool and based at least in part on performing the one or more deterministic operations, a screenshot of the GUI displaying the one or more security settings of the EDR system;
obtain, based at least in part on the screenshot of the GUI, one or more vectors between a cursor on the GUI and a GUI element corresponding to a security setting of the one or more security settings;
disable the security setting based at least in part on using the tool to navigate the cursor to the GUI element via the one or more vectors and interacting with the GUI element; and
perform, during the autonomous pentest, one or more second autonomous pentesting operations after disabling the security setting.

18. The non-transitory computer-readable medium of claim 17, wherein the instructions are further executable by the one or more processors to:
disable, after disabling the security setting, the EDR system, wherein performing the one or more second autonomous pentesting operations is based at least in part on disabling the EDR system.

19. The non-transitory computer-readable medium of claim 18, wherein the instructions are further executable by the one or more processors to:
select the one or more second autonomous pentesting operations from a first set of autonomous pentesting operations available based on the EDR system being disabled, wherein the first set of autonomous pentesting operations are at least partially different from a second set of autonomous pentesting operations available based on the EDR system being enabled.

20. The non-transitory computer-readable medium of claim 17, wherein the instructions are further executable by the one or more processors to:
identify, using a large language model (LLM), the one or more vectors based at least in part on a first location of the cursor on the GUI and a second location of the GUI element on the GUI, wherein the one or more vectors correspond to a path between the first location and the second location, and wherein obtaining the one or more vectors is based at least in part on the identifying.
